(19) United States
(12) Patent Application Publication
(10) Pub. No.: US 2014/0153722 A1
(43) Pub. Date: Jun. 5, 2014

(54) RESTRICTING USE OF MOBILE SUBSCRIPTIONS TO AUTHORIZED MOBILE DEVICES

(71) Applicant: Semyon Mizikovsky, Morganville, NJ (US)

(72) Inventor: Semyon Mizikovsky, Morganville, NJ (US)

(21) Appl. No.: 13/839,585

(22) Filed: Mar. 15, 2013

Related U.S. Application Data
(60) Provisional application No. 61/732,729, filed on Dec. 3, 2012.

(51) Int. Cl. H04W 12/06

(52) U.S. Cl. CPC H04W 12/06
USPC 380/270

(57) ABSTRACT

An authentication capability is depicted and described. A user device (UD) attempts to attach to a network. The UD includes a mobile equipment (ME) portion and a network authentication module (NAM) having a mobile subscription associated therewith. The network has a network device associated therewith. Cryptographic processing of an authentication challenge parameter is performed on both the network device and the ME of the UD in order to generate a modified authentication challenge parameter. The network device uses the modified authentication challenge parameter to compute one or more parameters related to authentication. The ME of the UD provides the modified authentication challenge parameter to the NAM of the UD, which uses the modified authentication challenge parameter to compute one or more parameters related to authentication. The authentication capability supports authentication of the mobile subscription of the NAM of the UD when the UD attempts to attach to the network.

### CROSS-REFERENCE TO RELATED APPLICATION

This application claims the benefit of U.S. Provisional Patent Application Ser. No. 61/732,729, entitled “RESTRICTING USE OF MOBILE SUBSCRIPTIONS TO AUTHORIZED MOBILE DEVICES,” filed Dec. 3, 2012, which is hereby incorporated herein by reference in its entirety.

### TECHNICAL FIELD

The disclosure relates generally to communication networks and, more specifically but not exclusively, to network authentication procedures for communication networks.

### BACKGROUND

In many types of networks, authentication and security capabilities are utilized to prevent the use of network access subscriptions with unauthorized devices.

### SUMMARY OF EMBODIMENTS

Various deficiencies in the prior art may be addressed by embodiments related to cryptographic processing of an authentication challenge parameter.

In one embodiment, an apparatus includes at least one processor and at least one memory, where the at least one processor is configured to process an authentication challenge parameter based on a cryptographic function to form a modified authentication challenge parameter and generate one or more authentication parameters based on the modified authentication challenge parameter.

In one embodiment, a method includes using at least one processor and at least one memory for processing an authentication challenge parameter based on a cryptographic function to form a modified authentication challenge parameter and generating one or more authentication parameters based on the modified authentication challenge parameter.

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary wireless communication system;

FIG. 2 depicts an exemplary embodiment for generation of an AV by a network device of the exemplary communication system of FIG. 1 where the exemplary wireless communication system of FIG. 1 supports a 3GPP AKA procedure;

FIG. 3 depicts an exemplary embodiment for generation of authentication procedure parameters by a network device and a user device of the exemplary communication system of FIG. 1 where the exemplary wireless communication system of FIG. 1 supports an authentication procedure;

FIG. 4 depicts an exemplary embodiment of a method for use by a network device to generate an authentication vector when a user device attempts to attach to a radio access network;

FIG. 5 depicts an exemplary embodiment of a method for use by a user device when the user device attempts to attach to a radio access network; and

FIG. 6 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, an authentication capability is depicted and described herein. Various embodiments of the authentication capability relate to authentication procedures that may be used in order to authenticate mobile subscriptions and generate session protection security associations when user devices (UDs) attempt to access Radio Access Networks (RANs). In general, a UD may be composed of a Mobile Equipment (ME) and a Network Authentication Module (NAM). The ME includes a processor and a memory (as well as other components, as will be appreciated by one skilled in the art). The ME has a hardware identity associated therewith. The ME also may be referred to herein as a Mobile Shell (MS), a Mobile Device (MD), or, more generally, as a user device shell that does not include a NAM. The NAM may be implemented as a card (e.g., a Universal Integrated Circuit Card (UICC)), a software-based NAM configured to run on a processor, or the like. In general, a NAM may have a processor and a memory associated therewith. The NAM of a UD maintains user subscription credentials for a mobile subscription and performs secure computations associated with the mobile subscription (e.g., computations associated with authentication and session key agreements) when the UD attempt to access a RAN. A network device associated with the RAN facilitates authentication of the mobile subscription when the UD attempts to access the RAN.

In at least some embodiments, forward cryptographic processing of a authentication challenge parameter is performed on both the network device and the ME of the UD in order to generate a modified authentication challenge parameter. The modified authentication challenge parameter is used on the network device to compute one or more parameters (e.g., one or more authentication parameters, one or more session security parameters, or the like, as well as various combinations thereof) sent by the network device (e.g., as an AV) toward the RAN. The authentication challenge parameter, rather than the modified authentication challenge parameter, is sent by the network device toward the RAN for delivery to the UD such that the ME of the UD also may generate the modified authentication challenge parameter and provide the modified authentication challenge parameter to the NAM of the UD for use by the NAM of the UD to compute one or more parameters (e.g., one or more authentication parameters, one or more session security parameters, or the like, as well as various combinations thereof). In this manner, regardless of the size of the authentication challenge parameter, the modified authentication challenge parameter computed on the network device and the ME of the UD will be same (and, thus, the one or more parameters computed on the network device and the one or more parameters computed by the NAM of the UD will be the same) as long as the same cryptographic function fx is used by the network device and the ME of the UD. It is noted that, given that only forward cryptographic processing of the authentication challenge parameter is used (and symmetric decryption of an encrypted authentication challenge parameter is not required), any suitable cryptographic function fx may be used on the network device and the ME of the UD, and, thus, various implementation details might be simplified.

In at least some embodiments, cryptographic processing of an authentication challenge parameter may be used to ensure that use of a NAM module (e.g., mobile subscription) to access a RAN is restricted to an authorized ME. The ME is provisioned with a device-specific secret key (denoted herein as a B-KEY) that is specific to the ME (e.g., associated with the hardware identity of the ME). The network device also is provisioned with the device-specific secret key of the ME (again, B-KEY), and maintains an association of the device-specific secret key of the ME to the NAM that is authorized to be used within the ME. As a result, a different NAM cannot be used within the ME in order to access the RAN and, similarly, the NAM cannot be used within a different ME in order to access the RAN.

It will be appreciated that, although primarily depicted and described herein with respect to embodiments for restricting use of an mobile subscription of a NAM to an authorized ME when a UD is attempting to access a RAN are depicted and described herein within the context of a Third Generation Partnership Project (3GPP) Authenticated Key Agreement (AKA) procedure that may be used to authenticate mobile subscriptions and generate session protection security associations when UDs access RANs, various embodiments for restricting use of an mobile subscription of a NAM to an authorized ME when a UD is attempting to access a RAN may be provided within the context of or in conjunction with various other types of AKA procedures or, more generally, authentication procedures.

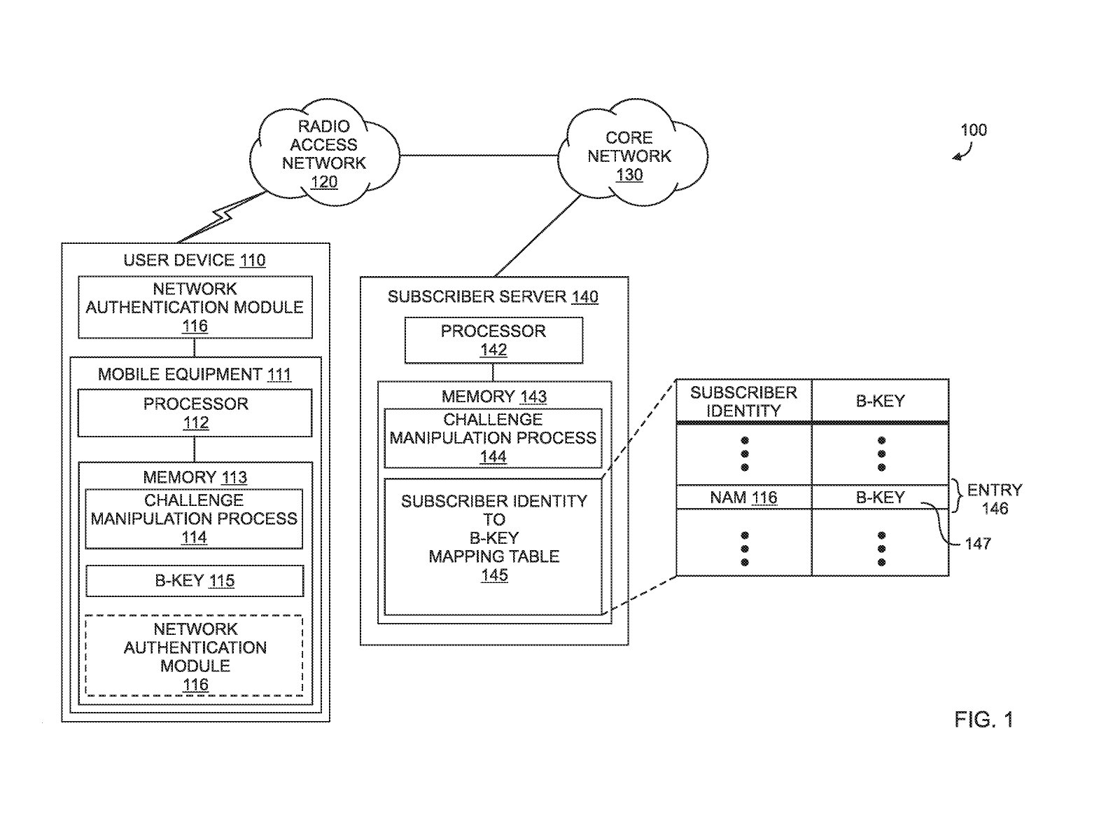

FIG. 1 depicts a high-level block diagram of an exemplary wireless communication system.

The exemplary wireless communication system 100 supports network authentication procedures. The network authentication procedures may be challenge-response authentication procedures, which may be AKA-based authentication procedures which use Authentication Vectors (AVs) during network authentication For example, the exemplary wireless communication system 100 may be a Second Generation (2G) cellular network (e.g., a 2G Global System for Mobile (GSM) cellular network, a 2G Code Division Multiple Access (CDMA) cellular network, or the like), a Third Generation (3G) cellular network (e.g., a 3G CDMA2000 network, a 3G Partnership Project (3GPP) Universal Mobile Telecommunication System (UMTS) network, or the like), a Fourth Generation (4G) cellular network (e.g., a Long Term Evolution (LTE) network), or the like.

The exemplary wireless communication system 100 includes a user device (UD) 110, a Radio Access Network (RAN) 120, a Core Network (CN) 130, and a Subscriber Server (SS) 140.

The UD 110 is a user device configured to support challenge-response authentication procedures, which may be AKA-based authentication procedures. The UD 110 includes a mobile equipment (ME) portion 111 (denoted as ME 111) and a network authentication module (NAM) 116).

The ME 111 includes a processor 112 and a memory 113 that is communicatively connected to the processor 112. The memory 113 stores various programs and data, including a challenge manipulation process 114 and a B-KEY value 115. The processor 112 is configured to retrieve challenge manipulation process 114 from memory 113 and execute the challenge manipulation process 114 to provide functions of the authentication capability. The challenge manipulation process 114 is configured to cryptographically process an authentication challenge parameter received at the ME 111 of UD 110 from the RAN 120 during a network authentication procedure. The challenge manipulation process 114 is configured to cryptographically process the authentication challenge parameter in order to form a modified authentication challenge parameter. The challenge manipulation process 114 is configured to cryptographically process the authentication challenge parameter using a device-specific secret key associated with the subscriber identity of the NAM 116 of UD 110. For example, the challenge manipulation process 114 may use a hash function (e.g., HA1, SHA256, MD5, or like hash functions), a cipher (e.g., Advanced Encryption Standard (AES), SNOW3G, KASUMI, or like ciphers), or the like. The ME 111 of UD 110 may retrieve the device-specific secret key associated with the subscriber identity of the NAM 116 of UD 110 from memory 113. As depicted in FIG. 1, the device-specific secret key associated with the subscriber identity of the NAM 116 of UD 110 is B-KEY 115. It is noted that the same B-KEY value is provisioned on SS 140 and used by SS 140 to cryptographically process the authentication challenge parameter generated by SS 140 when UD 110 attempts to attach to RAN 120. The operation of challenge manipulation process 114 is described in additional detail below.

The ME 111 of UD 110 (namely, UD 110 excluding NAM 116) has an equipment identity associated therewith. The equipment identity of the ME 111 of UD 110 may depend on the RAT of RAN 120. For example, the ME 111 of UD 110 may have an International Mobile Equipment Identifier (IMEI) or Mobile Equipment Identifier (MEID) associated therewith. In cases in which the ME 111 of UD 110 is required to provide its equipment identity as part of the network authentication procedure, the manner in which the ME 111 of UD 110 provides its equipment identity to the RAN 120 may depend on the RAT of RAN 120. For example, the ME 111 of UD 110 may provide its equipment identity (e.g., IMEI, MEID, or the like) in the initial Attach Request sent by UD 110 to RAN 120, or the equipment identity of the ME 111 of UD 110 may be requested from UD 110 by RAN 120 in a separate transaction.

The UD 110 also includes a network authentication module (NAM) 116. The NAM 116 is configured to support challenge-response authentication procedures, which may be AKA-based authentication procedures. It will be appreciated that, without the NAM 116, UD 110 may merely be a shell which may be referred to as a mobile equipment (e.g., ME 111), a Mobile Shell (MS), a Mobile Device (MD), or, more generally, as a UD shell that does not include a NAM.

The NAM 116 is associated with a network subscription of a subscriber. The NAM 116 ensures integrity and security of personal data of the subscriber using UD 110. The NAM 116 includes subscription credentials (e.g., a subscriber identity, such as an International Mobile Subscriber Identity (IMSI), a Temporary Mobile Subscription Identity (TMSI), a Globally Unique Temporary Identity (GUTI), or the like), one or more subscription secrets, one or more algorithms for subscription authentication and generation of security keys for protecting session information, and the like.

As depicted in FIG. 1, NAM 116 may be implemented in any suitable manner, which may depend on the underlying Radio Access Technology (RAT) of the RAN 120.

In one embodiment, as depicted in FIG. 1, the NAM 116 is a physically removable device that is inserted into UD 110. In this embodiment, the NAM 116 may be a smartcard. In the case of a GSM network, for example, the NAM 116 may be a Subscriber Identity Module (SIM) card. In the case of a UMTS network or an LTE network, for example, the NAM 116 may be a Universal Integrated Circuit Card (UICC). The NAM 116 may be any other suitable type of card or device. In such embodiments, for example, NAM 116 may include a Central Processing Unit (CPU), Read-Only Memory (ROM), Random Access Memory (RAM), input-output (I/O) circuits, or the like (which elements are omitted for purposes of clarity).

In one embodiment, as depicted in FIG. 1, the NAM 116 is a software-based module stored within UD 110 (e.g., in the memory 113 or in any other suitable storage location within UD 110).

The NAM 116 supports one or more applications, at least some of which may depend on the underlying RAT (e.g., a CDMA Subscriber Identity Module (CSIM) application for a CDMA2000 network, a UMTS Subscriber Identity Module (USIM) application for a UMTS network or an LTE network, or the like).

The NAM 116 has a subscriber identity associated therewith. The subscriber identity of NAM 116 may depend on the RAT of RAN 120. For example, NAM 116 may have one or more subscriber identities (e.g., an International Mobile Subscriber Identity (IMSI), a Temporary Mobile Subscription Identity (TMSI), a Globally Unique Temporary Identity (GUTI), or the like) associated therewith. The manner in which UD 110 provides the subscriber identity of NAM 116 during the network authentication procedure may depend on the RAT of RAN 120. For example, UD 110 may provide the IMSI of NAM 116 in the initial Attach Request sent by UD 110 to RAN 120, or UD 110 may provide the TMSI or the GUTI in the initial Attach Request (with the IMSI subsequently being resolved by RAN 120).

It will be appreciated that, although omitted for purposes of clarity, UD 110 may include various other modules and functions typically supported by mobile devices (e.g., a mobile operating system, one or more network interfaces to one or more types of wireless access networks, one or more client modules (e.g., a camera client module, a video client module, or the like), a battery, and the like).

The RAN 120 and CN 130 may support any suitable type of wireless communications. For example, RAN 120 and CN 130 may support one or more of 2G cellular communications, 3G cellular communications, 4G cellular communications, or the like, as well as various combinations thereof. The RAN 120 provides a wireless access interface for UD 110, supporting communications between UD 110 and CN 130. The RAN 120 supports network authentication procedures. The typical operation of RAN 120 and CN 130 will be understood by one skilled in the art.

The SS 140 is configured to provide security and authentication functions for authenticating mobile devices accessing RAN 120 (illustratively, UD 110). For example, SS 140 may be implemented as a Home Location Register (HLR) (e.g., in a GSM network), as a Home Subscriber Server (HSS) (e.g., in a UMTS network), or the like, as well as various combinations thereof.

The SS 140 includes a processor 142 and a memory 143. The memory 143 stores various programs and associated data. More specifically, the memory 143 stores a challenge manipulation process 144 and a subscriber identity to B-KEY mapping table 145. The processor 142 is configured to retrieve challenge manipulation process 144 from memory 143 and execute the challenge manipulation process 144 to provide functions of the authentication capability. The challenge manipulation process 144 is configured to cryptographically process an authentication challenge parameter that is generated by SS 140 in response to an AV request received from RAN 120 for UD 110 when UD 110 is requesting to attach to RAN 120. The challenge manipulation process 144 is configured to cryptographically process the authentication challenge parameter in order to form a modified authentication challenge parameter. The challenge manipulation process 144 is configured to cryptographically process the authentication challenge parameter using a device-specific secret key associated with the subscriber identity of the NAM 116 of UD 110. For example, the challenge manipulation process 114 may use a hash function (e.g., HA1, SHA256, MD5, or like hash functions), a cipher (e.g., AES, SNOW3G, KASUMI, or like ciphers), or the like. The SS 140 may retrieve the device-specific secret key associated with the subscriber identity of the NAM 116 of UD 110 the subscriber identity to B-KEY mapping table 145 based on the subscriber identity of the NAM 116 of UD 110. As depicted in FIG. 1, the device-specific secret key associated with the subscriber identity of the NAM 116 of UD 110 is B-KEY 147 in entry 146 of the subscriber identity to B-KEY mapping table 145. It is noted that the same B-KEY value is provisioned on UD 110 and used by UD 110 to cryptographically process the authentication challenge parameter received by UD 110 from RAN 120). The operation of challenge manipulation process 144 is described in additional detail below. It is noted that, although primarily depicted and described as being part of SS 140, the challenge manipulation process 144 may be implemented as an adjunct process or an adjust module associated with or otherwise capable of communicating with SS 140 (e.g., as a process on another device, as a standalone device, or the like, as well as various combinations thereof).

The subscriber identity to B-KEY mapping table 145 includes subscriber identity to B-KEY mapping information, including an entry 146 associated with NAM 116 that includes a mapping of the subscriber identity of NAM 116 to a B-KEY 147. It is noted that, although primarily depicted and described with respect to embodiments in which the subscriber identity to B-KEY mapping information is maintained separate from other information maintained by SS 140, the subscriber identity to B-KEY mapping information may be maintained in any other suitable manner (e.g., via inclusion in one or more existing tables of SS 140 (which are omitted for purposes of clarity), as part of challenge manipulation process 144, or the like, as well as various combinations thereof). It is noted that, although primarily depicted and described herein with respect to embodiments in which the subscriber identity to B-KEY mapping table 145 is stored in a memory within SS 140 (illustratively, memory 143), the subscriber identity to B-KEY mapping table 145 may be maintained using one or more databases associated with SS 140. The subscriber identity to B-KEY mapping information may be maintained and made accessible to SS 140 in any other suitable manner.

The exemplary wireless communication system 100 is configured to support AKA-based authentication procedures which use embodiments of the authentication capability.

The UD 110 initiates a service attach procedure in which UD 110 attempts to attach to RAN 120. The UD 110 determines a subscriber identity associated with the NAM 116 of UD 110. The UD 110 sends an initial attach request to the RAN 120. The type of subscriber identity that is provided to RAN 120 by UD 110 (and, the manner in which the subscriber identity is provided to RAN 120 by UD 110) may depend on the access protocol being used by UD 110, which may in turn depend on the RAT of RAN 120.

The RAN 120, in response to receiving the initial attach request from UD 110, proceeds with the AKA-based authentication procedure as specified in the standard(s) applicable to the RAN 120. The AKA-based authentication procedure may be a 3GPP AKA procedure. The RAN 120, as part of the AKA-based authentication procedure, sends an AV request to SS 140. The AV request includes the subscriber identity of the NAM 116 of UD 110.

The SS 140 receives the AV request from the RAN 120 and generates an AV in response to the AV request received from the RAN 120. In general, a standard AV includes an authentication challenge parameter, an expected challenge response parameter, and one or more other parameters (e.g., one or more Session Keys, an Authentication Token, or the like, as well as various combinations thereof). The numbers and types of parameters included within the AV may depend on the underlying RAT of RAN 120. In the case of a GSM network, for example, the generated AV may include a RAND parameter (i.e., the authentication challenge parameter), a signed response (SRES) (i.e., the expected response), and a Session Key. In the case of a UMTS network, for example, the generated AV may include a RAND parameter (i.e., the authentication challenge parameter), an XRES (i.e., the expected response), Session Keys (including a Ciphering Key (CK) and an Integrity Key (IK)), and an Authentication Token (AUTN). In the case of a LTE network, for example, the generated AV may include a RAND parameter (i.e., the authentication challenge parameter), an XRES (i.e., the expected response), a Session Key (K_{ASME}), and an Authentication Token (AUTN). In each case, the AV includes an authentication challenge parameter and, optionally, may include one or more other parameters (as discussed in additional detail below). It will be appreciated that parameters typically included within AVs of various RATs will be understood by one skilled in the art.

The SS 140, before generating the AV for the RAN 120, processes the authentication challenge parameter to generate a modified authentication challenge parameter (which also may be referred to as a cryptographically-processed authentication challenge parameter). The SS 140 may execute challenge manipulation process 144 in order to process the authentication challenge parameter to generate the modified authentication challenge parameter. The SS 140 generates the modified authentication challenge parameter by cryptographically processing the authentication challenge parameter using a cryptographic function fx that takes the authentication challenge parameter and a device-specific secret key (namely, B-KEY 147) as inputs. The cryptographic function fx may be a hash function, a cipher, or any other suitable cryptographic function. For example, the cryptographic function may use a hash function (e.g., HA1, SHA256, MD5, or like hash functions), a cipher (e.g., AES, SNOW3G, KASUMI, or like ciphers), or the like. The B-KEY 147 that is associated with the subscriber identity of the NAM 116 may be retrieved from the subscriber identity to B-KEY mapping table 145, using the subscriber identity of NAM 116 as a key into the subscriber identity to B-KEY mapping table 145. It is noted that, while SS 140 does not necessarily require the equipment identity of UD 110 (e.g., SS 140 may simply assume, based on presence of the B-KEY 147 in the entry 146 that is associated with the NAM 116 of UD 110, that UD 110 that is currently being used with the NAM 116 is provisioned with the correct B-KEY), the SS 140 also may be configured to check the equipment identity of UD 110 where such information is available to SS 140.

The SS 140 generates one or more authentication procedure parameters which may be used in conjunction with the authentication procedure. The SS generates the one or more authentication procedure parameters based on the modified authentication challenge parameter. The SS 140 may generate the one or more authentication procedure parameters by applying the modified authentication challenge parameter to one or more cryptographic functions fy (e.g., functions f1-f5) in order to generate the one or more authentication challenge parameters to be used in conjunction with the authentication procedure.

The one or more authentication procedure parameters include at least one authentication parameter and, optionally, may include at least one of one or more session security parameters, one or more other types of parameters, or the like.

The at least one authentication parameter includes a challenge response parameter (e.g., the XRES parameter in the 3GPP AKA procedure), which may be used to validate the authenticity of UD 110. The at least one authentication parameter also may include an authentication parameter used to validate the authenticity of the RAN 120 (e.g., an authentication token such as the AUTN parameter in the 3GPP AKA procedure). The at least one authentication parameter also may include any other suitable type(s) of authentication parameter(s), which may vary for different types of authentication procedures in which forward cryptographic processing of the authentication challenge parameter may be used.

The one or more session security parameters may include one or more session security parameters for use by RAN 120 in securing communications between RAN 120 and UD 110 (e.g., one or more session keys, such as a ciphering key and an integrity key (e.g., the CK and IK parameters in the 3GPP AKA procedure or any other suitable number(s) and type(s) of session keys)). The one or more session security parameters may include any other suitable types of session security parameters, which may vary for different types of authentication procedures in which forward cryptographic processing of the authentication challenge parameter may be used.

The SS 140 generates the AV in response to the AV request from the RAN 120 and sends the generated AV to the RAN 120. The AV includes the authentication challenge parameter and the challenge response parameter, and, optionally, also may include at least one other authentication procedure parameter (e.g., at least one other authentication parameter, one or more session security parameters, or the like, as well as various combinations thereof).

The RAN 120 receives the AV from the RAN. As noted above, the AV includes the authentication challenge parameter and the challenge response parameter, and, optionally, also may include at least one other authentication procedure parameter. The RAN 120 retains the challenge response parameter for future use by RAN 120. The RAN 120 forwards the authentication challenge parameter to UD 110 (received by ME 111 of UD 110). The RAN 120, when one or more other authentication procedure parameters are received at RAN 120 from SS 140, also may retain at least one of the one or more other authentication procedure parameters for future use by RAN 120 or may forward at least one of the one or more other authentication procedure parameters to UD 110 (received by ME 111 of UD 110).

The ME 111 of UD 110 (e.g., processor 112) receives the authentication challenge parameter from RAN 120. The ME 111 of UD 110 processes the authentication challenge parameter in order to generate a modified authentication challenge parameter (which also may be referred to herein as a cryptographically-processed authentication challenge parameter). The ME 111 of UD 110 may execute challenge manipulation process 114 in order to process the authentication challenge parameter to generate the modified authentication challenge parameter. The ME 111 of UD 110 generates the modified authentication challenge parameter by cryptographically processing the authentication challenge parameter using a cryptographic function fx that takes the authentication challenge parameter and a device-specific secret key (namely, B-KEY 115) as inputs. The cryptographic function fx may be a hash function, a cipher, or any other suitable cryptographic function. For example, the cryptographic function fx may be a hash function (e.g., HA1, SHA256, MD5, or like hash functions), a cipher (e.g., Advanced Encryption Standard (AES), SNOW3G, KASUMI, or like ciphers), or the like. It will be appreciated that the cryptographic function fx used by the ME 111 of UD 110 and the cryptographic function fx used by SS 120 are selected, configured, and profiled the same. The device-specific secret key that is associated with the subscriber identity of the NAM 116 may be retrieved from the memory 113 of the ME 111 of UD 110 (e.g., where the B-KEY 115 is pre-provisioned on UD 110) or may be accessed by ME 111 of UD 110 from a suitable source of the device-specific secret key. It will be appreciated that, as long as the cryptographic function fx used by the ME 111 of UD 110 is the same as the cryptographic function fx used by SS 140, the modified authentication challenge parameter generated by ME 111 of UD 110 will be the same as the modified authentication challenge parameter generated by SS 140. The ME 111 of UD 110 provides the modified authentication challenge parameter to the NAM 116 of UD 110. The ME 111 of UD 110, when one or more other authentication procedure parameters are received by the ME 111 of UD 110 from the RAN 120, may provide at least one of the one or more other authentication procedure parameters to the NAM 116 of UD 110.

The NAM 116 of UD 110 receives the modified authentication challenge parameter from the ME 111 of UD 110. The NAM 116 of UD 110 computes a challenge response parameter based on the modified authentication challenge parameter and provides the computed challenge response parameter to the ME 111 of UD 110. The NAM 116 of UD 110 also may compute one or more other authentication parameters (e.g., one or more session keys) based on the modified authentication challenge parameter and provide the one or more other authentication parameters to the ME 111 of UD 110. The NAM 116 of UD 110, when one or more of other authentication procedure parameters computed by SS 140 are received at UD 110 from RAN 120 and provided from the ME 111 of UD 110 to the NAM 116 of UD 110, also may validate at least one of the one or more other authentication procedure parameters (e.g., for authenticating the network device or any other suitable device).

The ME 111 of UD 110 (e.g., processor 112) receives the computed challenge response parameter from the NAM 116 of UD 110 and sends the computed challenge response parameter to RAN 120. The ME 111 of UD 110, when the NAM 116 of UD 110 computes one or more other authentication procedure parameters and provides the one or more other authentication procedure parameters to the ME 111 of UD 110, also may retain at least one of the one or more other authentication procedure parameters (e.g., one or more session keys where the NAM 116 of UD 110 computes the one or more session keys based on the modified authentication challenge parameter) for use at the ME 111 of UD 110.

The RAN 120 receives the challenge response parameter from UD 110. The RAN 120 compares the challenge response parameter received from UD 110 to the challenge response parameter received from SS 140. If the challenge response parameters match, authentication of UD 110 is successful and UD 110 is permitted to attach to RAN 120. If the challenge response parameters do not match, an authentication failure occurs for UD 110 and UD 110 is prevented from attaching to RAN 120.

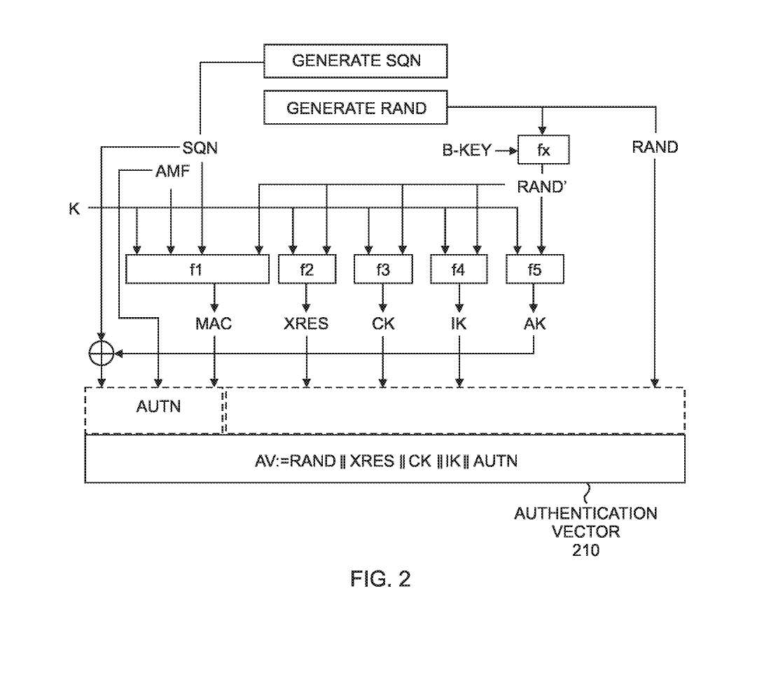

As described herein, the numbers and types of parameters included within the AV may vary across different network types. Various embodiments of the authentication capability are primarily depicted and described herein within the context of a 3GPP AKA procedure. Thus, various embodiments for generation and use of a modified authentication challenge parameter when generating an AV may be better understood by considering generation and use of a modified authentication challenge parameter to generate an AV within the context of a 3GPP AKA procedure, as depicted and described with respect to FIG. 2.

FIG. 2 depicts an exemplary embodiment for generation of an AV by a network device of the exemplary communication system of FIG. 1 where the exemplary wireless communication system of FIG. 1 supports a 3GPP AKA procedure.

As depicted in FIG. 2, AV 210 includes the RAND (authentication challenge parameter), XRES, CK, IK, and AUTN parameters. The manner in which the RAND, XRES, CK, IK, and AUTN parameters are obtained for use in the AV also is depicted.

The authentication challenge parameter RAND and a Sequence Number (SQN) are generated. The authentication challenge parameter RAND and a device-specific secret key (illustratively, B-KEY) are input into a cryptographic function fx in order to generate the modified authentication challenge parameter (denoted as RAND′). The modified authentication challenge parameter RAND′ is then input into each of five functions (denoted as f1, f2, f3, f4, and f5) for use in generating a Message Authentication Code (MAC) parameter (for use in generating the AUTN parameter) and the XRES, CK, IK, and AK parameters, respectively.

The function f1 generates the MAC parameter based on inputs of the K parameter, an AMF parameter, the SQN parameter, and the modified authentication challenge parameter RAND′.

The function f2 generates the XRES parameter based on inputs of the K parameter and the modified authentication challenge parameter RAND′.

The function f3 generates the CK parameter based on inputs of the K parameter and the modified authentication challenge parameter RAND′.

The function f4 generates the IK parameter based on inputs of the K parameter and the modified authentication challenge parameter RAND′.

The function f5 generates the AK parameter based on inputs of the K parameter and the modified authentication challenge parameter RAND′.

The AUTN parameter is generated by combining (1) an exclusive OR of the SQN parameter and the AK parameter, (2) the AMF parameter, and (3) the MAC parameter generated by function f1.

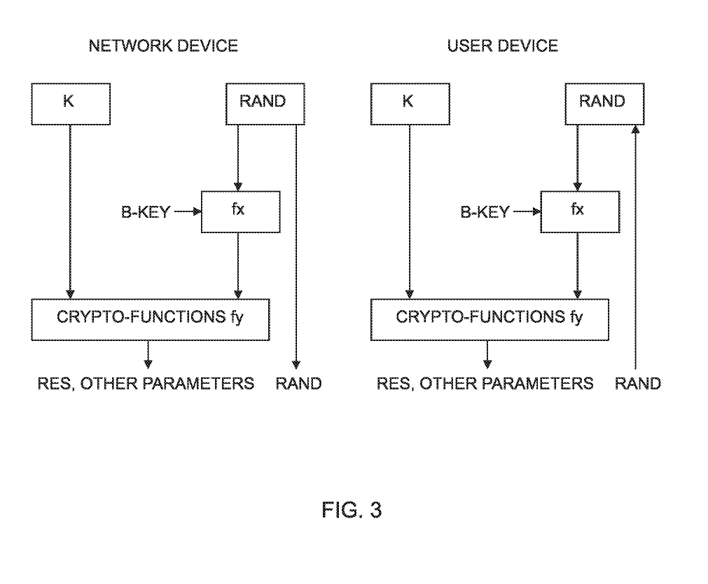

Thus, it will be appreciated that, more generally, a network device may generate one or more authentication procedure parameters by applying the modified authentication challenge parameter to various cryptographic functions fy in order to generate various parameters to be used in conjunction with the authentication procedures. Additionally, it will be appreciated that, more generally, use of the modified authentication challenge parameter to generate one or more authentication procedure parameters may be performed at both the network device as well as at a user device that is attempting to access a radio access network associated with the network device. Thus, application of a modified authentication challenge parameter to various cryptographic functions fy in order to generate various authentication procedure parameters within the context of a 3GPP AKA procedure may be more generally represented as depicted and described with respect to FIG. 3.

FIG. 3 depicts an exemplary embodiment for generation of authentication procedure parameters by a network device and a user device of the exemplary communication system of FIG. 1 where the exemplary wireless communication system of FIG. 1 supports an authentication procedure.

As depicted in FIG. 3, on the network device: (1) an authentication challenge parameter RAND and a device-specific secret key (illustratively, B-KEY) are input into a cryptographic function fx in order to generate the modified authentication challenge parameter (denoted as RAND′), (2) the modified authentication challenge parameter RAND′ and a K parameter are input into a set of crypto-functions fy (e.g., functions f1-f5) in order to generate an expected response parameter (denoted as RES) and, optionally, one or more other authentication procedure parameters, and (3) the authentication challenge parameter RAND, the RES parameter and, optionally, one or more other authentication procedure parameters are output (e.g., into an AV to be propagated from the network device toward a radio access network to which the user device is attempting to attach).

As further depicted in FIG. 3, on the user device: (1) an authentication challenge parameter RAND is received as an input (e.g., from a radio access network for which the network device is providing authentication procedures and to which the user device is attempting to attach), (2) the authentication challenge parameter RAND and a device-specific secret key (illustratively, B-KEY) are input into a cryptographic function fx in order to generate the modified authentication challenge parameter (denoted as RAND′), (3) the modified authentication challenge parameter RAND′ and a K parameter are input into a set of crypto-functions fy in order to generate an expected response parameter (RES) and, optionally, one or more other authentication procedure parameters, and (4) the RES parameter and, optionally, one or more other authentication procedure parameters are output (e.g., from the mobile device back to the radio access network for which the network device is providing authentication procedures and to which the user device is attempting to attach).

It will be appreciated that, for at least some embodiments, FIG. 3 may be considered to represent a more generalized embodiment of FIGS. 1 and 2, illustrating generalized functions supported by a network device (illustratively, SS 140) and a user device (illustratively, UD 110), where the crypto-functions fy depicted in FIG. 3 may represent any cryptographic functions which may be used to compute authentication parameters (e.g., representing cryptographic functions f1-f5 of FIG. 2, representing one or more functions which may be used to compute one or more authentication procedure parameters in one or more other authentication schemes, or the like). Accordingly, FIG. 3 may be considered to represent more general embodiments of the authentication capability that are adapted for use with various types of authentication procedures in addition to the 3GPP AKA procedure (e.g., Challenge-Handshake Authentication Protocol (CHAP), Hypertext Transfer Protocol (HTTP) Digest Authentication, GSM SIM, 3GPP2 CDMA2000, 3GPP2 1xRTT, or the like).

As described above, in order to support manipulation of the authentication challenge parameter, a secret B-KEY is provisioned into SS 140 and UD 110 for use as a key for manipulation of the authentication challenge parameter. It will be appreciated that the B-KEY values provisioned into SS 140 and UD 110 correspond to each other (e.g., B-KEY 147 of SS 140 is the same as B-KEY 115 of UD 110). In the case of a physically removable NAM 116, this ensures that, if NAM 116 is removed from UD 110 and placed into a different MD having a B-KEY that is different than the B-KEY 147 of SS 140, the different MD will not properly manipulate the authentication challenge parameter and, thus, the different MD will not be authenticated by RAN 120. In the case of a software-based NAM 116, this ensures that if the NAM 116 is hacked, the UD 110 will not be authenticated by the RAN 120. The provisioning of the same B-KEY value on UD 110 and SS 140 may be used to prevent or mitigate various other types of security threats.

The B-KEY value may be determined in any suitable manner (e.g., using any suitable value) and, similarly, may be provisioned into SS 140 (namely, as B-KEY 147) and UD 110 (namely, as B-KEY 115) in any suitable manner.

In one embodiment, for example, the B-KEY value may be a pre-provisioned random number or string. The pre-provisioning of the B-KEY value into UD 110 may be performed during device manufacturing, by the operator (or an affiliated entity) prior to deployment, using one or more device management mechanisms (e.g., Open Mobile Alliance-Device Management (OMA-DM)), or the like.

In one embodiment, for example, the B-KEY value may be a string (e.g., a key, password, or the like) that is provisioned into UD 110 during a bootstrapping procedure, while the same B-KEY is provisioned into SS 140 via a potentially proprietary mechanism (e.g., using an offline provisioning method).

In one embodiment, for example, the B-KEY value may be the output of a hash function. In this embodiment, the hash function may utilize any suitable input(s), such as one or more of (1) a random value, (2) a device-specific identity and/or parameter (e.g., an IMEI, a Media Access Control (MAC) address, a serial number, a model number, or the like, as well as various combinations thereof), or the like, as well as various combinations thereof.

In one embodiment, for example, the B-KEY value may be a number or string chosen using proprietary criteria.

The B-KEY value may be determined and provisioned into UD 110 and SS 140 in any other suitable manner.

In the foregoing description, an assumption is made that the UD 110 is authorized to use the NAM 116. The B-KEY 147 maintained in SS 140 is the same as the B-KEY 115 maintained in the UD 110 and, thus, the original authentication challenge parameter that is manipulated by SS 140 is correctly manipulated by UD 110 such that NAM 116 performs network authentication on the basis of the correct modified authentication challenge parameter and generates the correct challenge response and, thus, RAN 120 successfully validates UD 110.

In the case in which NAM 116 is a physically removable device that has been inserted into UD 110, if the NAM 116 were to be removed from UD 110 and placed in an unauthorized MD which does not include the correct B-KEY value, an attempt to attach to RAN 120 using the unauthorized MD would result in an incorrect manipulation of the authentication challenge parameter, which would result in an incorrect challenge response parameter and, thus, an authentication failure. In this manner, the NAM 116 is restricted from being used in any MD other than UD 110 for which it is authorized.

In the case in which NAM 116 is a software-based module stored within UD 110, if the NAM 116 were to be hacked, an attempt to attach to RAN 120 using the UD 110 would result in an incorrect manipulation of the authentication challenge parameter, which would result in an incorrect challenge response parameter and, thus, an authentication failure. In this manner, the NAM 116 is protected from being hacked.

Thus, only an authorized user device possessing the correct B-KEY value for a NAM can properly manipulate the authentication challenge parameter such that the NAM can generate the proper challenge response parameter and the user device can be successfully authenticated by the RAN. In this manner, a subscription-specific NAM is securely bound to an authorized user device under the full control of the Wireless Operator.

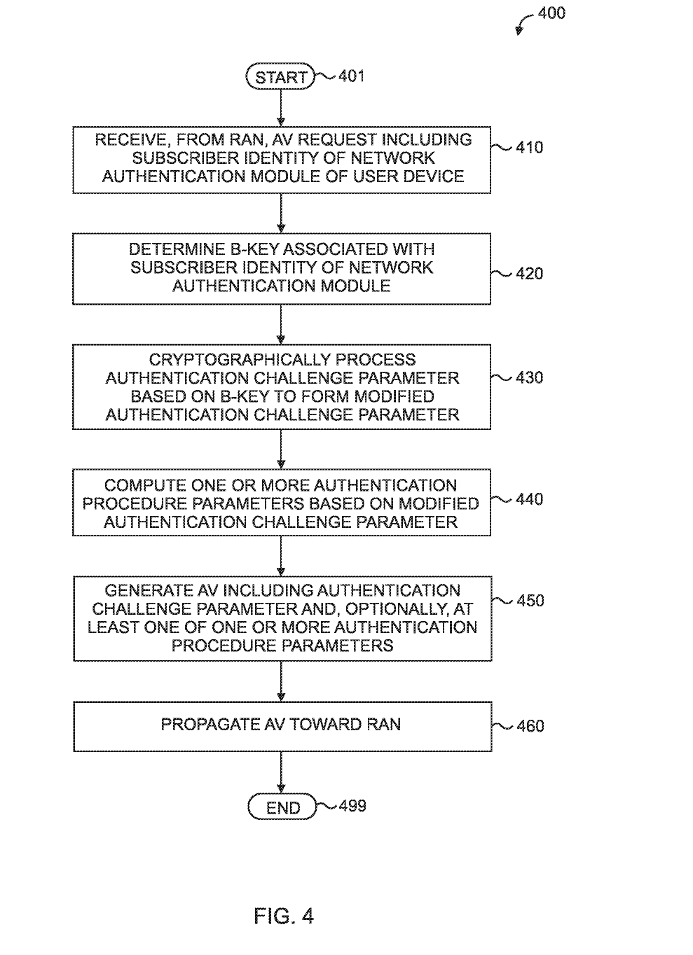

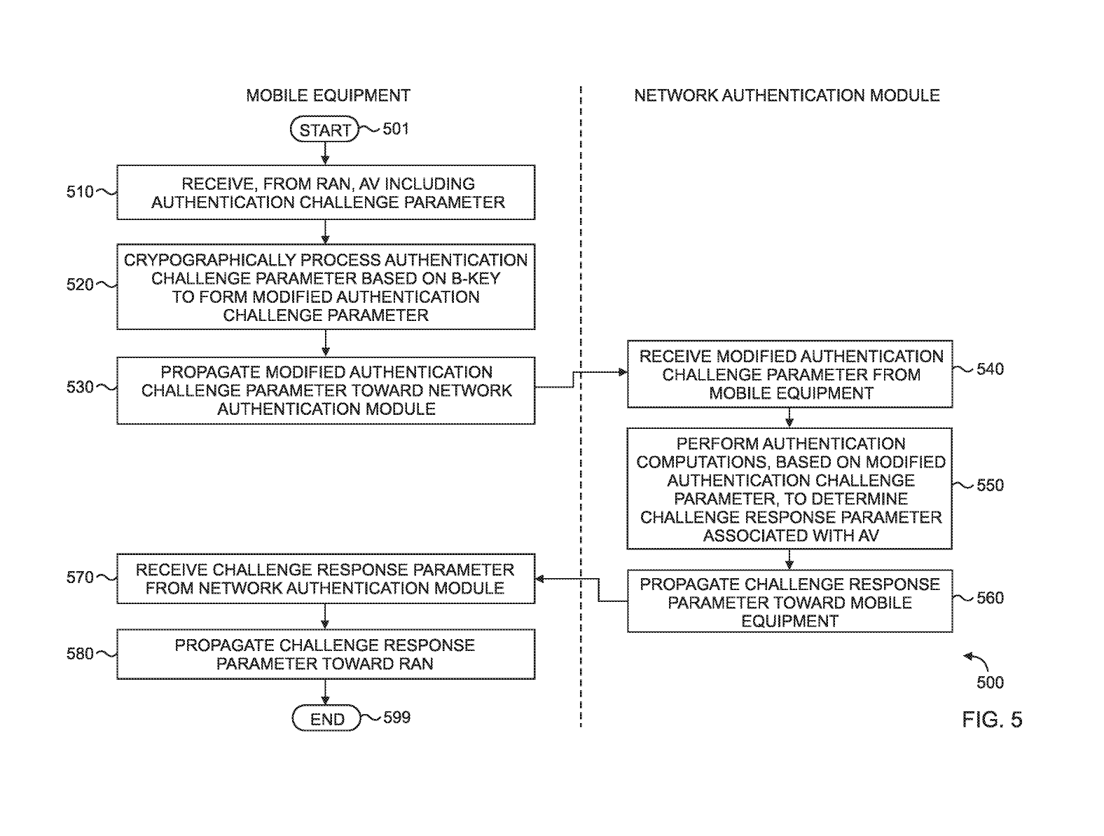

As noted above, various functions associated with manipulation of the authentication challenge parameter may be performed by SS 140 and UD 110. The functions performed by the SS 140 and the UD 110 for manipulating the authentication challenge parameter may be better understood by way of reference to FIG. 4 and FIG. 5, respectively.

FIG. 4 depicts an exemplary embodiment of a method for use by a network device to generate an authentication vector when a user device attempts to attach to a radio access network. The UD includes a NAM having a subscriber identity associated therewith. At step 401, the method 400 begins. At step 410, an AV request is received from the RAN. The AV request includes the subscriber identity of the NAM of the UD. At step 420, a B-KEY associated with the NAM is determined based on the subscriber identity of the NAM. At step 430, the authentication challenge parameter is cryptographically processed, using a cryptographic function and based on the B-KEY, to form a modified authentication challenge parameter. At step 440, one or more authentication procedure parameters are computed based on the modified authentication challenge parameter. At step 450, an AV, including the authentication challenge parameter and, optionally, at least one of the one or more authentication procedure parameters, is generated. At step 460, the AV is propagated toward the RAN. At step 499, method 400 ends. It is noted that the operation of the method 400 of FIG. 4 may be better understood when considered in conjunction with FIGS. 1-3.

FIG. 5 depicts an exemplary embodiment of a method for use by a user device when the user device attempts to attach to a radio access network. The UD includes an ME. The UD also includes a NAM having a subscriber identity associated therewith. As depicted in FIG. 5, a portion of the steps of method 500 are performed by the ME of the UD and a portion of the steps of method 500 are performed by the NAM of the UD. At step 501, the method 500 begins. At step 510, the ME receives an AV from the RAN. The AV is received in response to an Attach Request sent from the UD to the RAN. The AV includes an authentication challenge parameter. At step 520, the ME cryptographically processes the authentication challenge parameter, using a cryptographic function and based on a B-KEY that is stored on the ME, to form a modified authentication challenge parameter. At step 530, the ME propagates the modified authentication challenge parameter toward the NAM. At step 540, the NAM receives the modified authentication challenge parameter from the ME. At step 550, the NAM performs authentication computations, based on the modified authentication challenge parameter, to determine a challenge response parameter. At step 560, the NAM propagates the challenge response parameter toward the ME. At step 570, the ME receives the challenge response parameter from the NAM. At step 580, the ME propagates the challenge response parameter toward the RAN. At step 599, method 500 ends. It is noted that the operation of method 500 of FIG. 5 may be better understood when considered in conjunction with FIGS. 1-3.

Returning now to FIG. 1, it is noted that, although primarily depicted and described herein with respect to embodiments in which the authentication capability is used during authentication, the authentication capability also may be used during re-authentication performed in response to a synchronization failure. In a rare case of a synchronization failure, the modified authentication challenge parameter that is used by NAM 116 to generate the challenge response parameter is not reported back to RAN 120. Rather, only an authentication token (e.g., an AUTS token as defined in RFC 3310) is sent to RAN 120 by NAM 116 via ME 111 of UD 110, where the authentication token includes the expected value of the authentication synchronization parameter. The RAN 120 associates the received authentication token with the last used value of the authentication challenge parameter that was used during the previous authentication and provides the authentication token with the associated authentication challenge parameter to SS 140. The SS 140 (e.g., challenge manipulation process 144 or any other suitable process) manipulates the authentication challenge parameter before regenerating the AV for re-synchronization. In other words, the authentication challenge parameter received by SS 140 from RAN 120 in the synchronization failure transaction needs to be recovered (e.g., manipulated) before association with the authentication challenge parameter is restored and re-synchronization may be achieved. The manipulation of the authentication challenge parameter to form the modified authentication challenge parameter uses the same cryptographic function that was used to manipulate the authentication challenge parameter during the previous authentication of NAM 116. Similarly, the manipulation of the authentication challenge parameter to form the modified authentication challenge parameter uses the same B-KEY that was used to manipulate the authentication challenge parameter during the previous authentication of the NAM 116 (i.e., the B-KEY associated with the subscriber identity of the NAM 116). Thus, during re-synchronization, SS 140 performs processing that is similar to the processing performed by UD 110 during authentication.

It is noted that various embodiments of the authentication capability may be particularly useful within the context of Machine Type Communications (MTC). MTC is being defined by multiple standardization bodies to allow Wireless Operator support for Machine-to-Machine (M2M) communications. In general, M2M communications include communications by wireless devices without human interaction. It is increasingly expected that wireless devices involved in M2M communications, typically referred to as MTC devices or M2M devices, will be based on typical wireless mobile platforms while maximizing the use of existing wireless radio access and core network technologies. In other words, M2M/MTC-specific modifications to the commercial wireless architecture and infrastructure are expected to be reduced to a minimum. However, specifics of MTC/M2M feature operation require that a NAM associated with an MTC/M2M subscription can only be used in mobile devices that are specially designed as MTC/M2M devices and/or authorized to perform the M2M/MTC functions. Various embodiments of the authentication capability are adapted to restrict a NAM associated with an MTC/M2M subscription to a mobile device that is equipped to perform MTC/M2M functions and/or that is authorized to perform MTC/M2M functions. Various embodiments of the authentication capability are adapted to restrict the access of a NAM that is dedicated to be used only with MTC/M2M modules associated with a specific billing plan. Various embodiments of the authentication capability support the requirement, defined in 3GPP TS 22.368 (3^{rd} Generation Partnership Project; Technical Specification Group Services and System Aspects; Service requirements for Machine-Type Communications (MTC); Stage 1 (Release 11)), which restricts the use of a USIM to specific MTC/M2M devices (as well as similar requirements which may be specified in other standards, e.g., 3GPP2 S.P0146-0 Version 0.50 (Machine-to-Machine Communication System Requirements, Stage 1 Requirements, February 2012) or the like). In one embodiment, a specially equipped or authorized MTC/M2M device is provisioned with a secret B-KEY value (associated with one or both of an equipment identity of the specially equipped or authorized MTC/M2M device or a subscriber identity of a NAM of the specially equipped or authorized MTC/M2M device), which is also stored in a database in the network of the home operator for use in post-processing an AV that is generated in the network of the home operator when the specially equipped or authorized MTC/M2M device is authenticated for access to an access network.

It is noted that, although primarily depicted and described herein with respect to embodiments in which SS 140 computes the AV for UD 110 when the AV request is received from RAN 120, in at least some embodiments SS 140 may pre-compute and store the AV for UD 110 prior to receipt of the AV request from RAN 120. In this embodiment, the AV associated with UD 110 may be retrieved by SS 140 when the AV request is received from RAN 120. The SS 140 is able to manipulate the authentication challenge parameter is advance of receipt of the AV request, because SS 140 already maintains the associated information for NAM 116. This prevents SS 140 from having to generate the AV, including manipulation of the authentication challenge parameter to form the modified authentication challenge parameter, in real time when the AV request is received. Thus, SS 140 may be configured to obtain the AV for UD 110 when the AV request is received from RAN 120, where obtaining the AV for UD 110 may be considered to include computing the AV when the AV request is received or retrieving the AV when the AV request is received. The pre-computed AV may be stored in any suitable type of storage module (e.g., buffer, cache, or the like). The SS 140 may be configured to pre-compute multiple AVs for multiple subscriptions in advance and to store the pre-computed AVs such that the pre-computed AVs are available for retrieval when the associated UDs attempt to access RAN 120.

It will be appreciated that, although primarily depicted and described with respect to embodiments in which the AV received at RAN 120 from SS 140 is provided to UD 110, in at least some embodiments only a portion of the AV received at RAN 120 from SS 140 is provided to UD 110. In at least some embodiments in which RAN 120 is a GSM-based network, for example, only the authentication challenge parameter (i.e., RAND) of the AV may be provided from RAN 120 to UD 110. In at least some embodiments in which RAN 120 is a UMTS-based network, for example, only the authentication challenge parameter (i.e., RAND) and the authentication token (i.e., AUTN) of the AV are provided from RAN 120 to UD 110. In at least some embodiments in which RAN 120 is an LTE-based network, for example, only the authentication challenge parameter (i.e., RAND) and the authentication token (i.e., AUTN) of the AV are provided from RAN 120 to UD 110. It is noted that, in each case, at least the authentication challenge parameter of the AV is provided from RAN 120 to UD 110.

It will be appreciated that, although primarily depicted and described with respect to use of a specific type of data structure to propagate authentication procedure parameters from a network device to a user device (namely, an AV including specific parameters), any suitable type(s) of data structure(s) may be used to propagate authentication procedure parameters from a network device to a user device.

It is noted that, although primarily depicted and described herein with respect to embodiments in which it is assumed that the authentication challenge parameter that is provided from SS 140 to RAN 120 to UD 110 is cryptographically processed on SS 140 and UD 110, in at least some embodiments the UD 110 may receive both authentication challenge parameters that need to be cryptographically processed and authentication challenge parameters that do not need to be cryptographically processed (e.g., UD 110 may be capable of supporting multiple subscriptions in which at least one subscription is configured to use a cryptographically processed authentication challenge parameter and at least one subscription is configured to use an authentication challenge parameter that does not need to be cryptographically processed. In at least some embodiments, SS 140 may be configured to determine whether or not an authentication challenge parameter needs to be cryptographically processed for use in computing authentication procedure parameters. Similarly, in at least some embodiments, UD 110 may be configured to determine whether or not an authentication challenge parameter needs to be cryptographically processed for use in computing authentication procedure parameters. In at least some embodiments, SS 140 and UD 110 may be configured to determine whether or not an authentication challenge parameter needs to be cryptographically processed based on a subscriber identity. It will be appreciated that such embodiments may be used, for example, when UD 110 includes a non-MTC/M2M subscription (e.g., a typical telephone service subscription) and an MTC/M2M subscription (e.g., for a heart rate monitor or any other MTC/M2M application), where (1) each access to RAN 120 by the non-MTC/M2M subscription results in use of an authentication challenge parameter that has not been cryptographically processed by SS 140 and, thus, does not need to be cryptographically processed by ME 111 of UD 110 before being provided to NAM 116 and (2) each access to RAN 120 by the MTC/M2M subscription results in use of an authentication challenge parameter that has been cryptographically processed and, does need to be cryptographically processed by ME 111 of UD 110 before being provided to NAM 116. It will be appreciated that this is merely one example of cases in which SS 140 and UD 110 may be configured to determine whether or not an authentication challenge parameter needs to be cryptographically processed. It also will be appreciated that, as primarily depicted and described herein, UD 110 may be configured such that it is not necessary to determine whether or not an authentication challenge parameter needs to be cryptographically processed.

It will be appreciated that, although primarily depicted and described herein with respect to embodiments in which NAM 116 is bound to a single authorized user device (illustratively, UD 110), in at least some embodiments NAM 116 may be authorized for use with multiple user devices such that NAM 116 may be used within any of the multiple user devices without any authentication failures. In at least some embodiments, this may be provided using a single B-KEY, where the same B-KEY is provisioned into each of the multiple user devices and into SS 140 (e.g., by mapping the equipment identities of each of the multiple user devices to the same B-KEY value using one or more mapping entries). In at least some embodiments, this may be provided using multiple B-KEY values associated with the multiple user devices, where each of the multiple user devices has one of the B-KEYs provisioned therein and each of the B-KEYs is provisioned into SS 140 and mapped to the multiple user devices within SS 140, respectively.

It will be appreciated that, although primarily depicted and described herein with respect to embodiments in which UD 110 has a single network authentication module associated therewith (illustratively, NAM 116), in at least some embodiments UD 110 may have multiple network authentication modules associated therewith (i.e., multiple network authentication modules may be used with UD 110). In at least some embodiments, UD 110 (1) is provisioned with multiple B-KEYs associated with the multiple network authentication modules which may be used with UD 110 and (2) upon receiving an AV including an authentication challenge parameter, selects the appropriate B-KEY to be used to cryptographically process the authentication challenge parameter based on the subscriber identity provided to UD 110 by the network authentication module during the authentication procedure.

It will be appreciated that, although primarily depicted and described herein with respect to embodiments in which NAM is bound to one or more UDs in a restricted manner, in at least some embodiments a NAM may be authorized for use with any UD. In at least some embodiments, the UD is not pre-provisioned with a B-KEY specific to the NAM as the value of the subscriber identity would not be known at the time of provisioning of the UD. Rather, in at least some embodiments, the UD is pre-provisioned with a B-KEY that is associated to the equipment identity of the UD and, similarly, the equipment identity to B-KEY mapping of the UD would be maintained in the associated SS. In this embodiment, the UD would report its equipment identity (in addition to the subscriber identity of the NAM of the UD) and the SS would use the equipment identity of the UD (rather than the subscriber identity of the NAM of the UD) in order to retrieve the associated B-KEY for the UD for use in cryptographically processing the authentication challenge parameter during authentication of the UD. In at least some embodiments, the SS also may verify that the equipment identity that is reported by the UD is authorized to be used with the subscriber identity of the NAM that is reported by the UD (e.g., using a subscriber identity to equipment identity mapping table maintained by the SS, or any other suitable source of such mapping information), since such a verification ensures that the NAM of the UD that is being authenticated is authorized to operate in the UD (i.e., in the device having the equipment identity reported by the UD).

It will be appreciated that various embodiments of the authentication capability may only result in modifications to user devices configured to support network authentication and to the subscriber server (e.g., HLR, HSS, or the like) supporting authentication for such users devices, but not necessarily to other elements (e.g., not to elements of the RAN, not to elements of the CN, and so forth).

It will be appreciated that, although primarily depicted and described with respect to use of the authentication capability within specific types of wireless communication networks (namely, cellular communication networks using AKA-based authentication procedures, such as 2G GSM networks, 2G, CDMA networks, 3G CDMA2000 networks, 3GPP 3G (UMTS) networks, 4G (LTE) networks, or the like), the authentication capability may be used within various other types of wireless communication networks. For example, the authentication capability may be used within a 3G CDMA2000 legacy network (e.g., where the RANDU parameter is manipulated), a 1xEV-DO network (e.g., where the CHAP-Challenge parameter is manipulated), or the like.

It will be appreciated that, although primarily depicted and described with respect to embodiments of the authentication capability implemented within a specific type of communication network using a specific type of authentication procedure (e.g., a UMTS-based 3G network supporting a 3GPP AKA-based authentication procedure), embodiments of the authentication capability may be implemented within any suitable types of communication networks supporting any suitable types of authentication procedures. For example, various embodiments of the authentication capability may be used within any suitable type of communication network configured to support a challenge-response authentication procedure, such as within other types of wireless networks (e.g., other types 3G wireless networks (e.g., an EV-DO network or the like), a 4G wireless network (e.g., an LTE network or the like), or the like, as well as various combinations thereof), within a wireline network configured to support a challenge-response authentication procedure, or the like, as well as various combinations thereof. For example, various embodiments of the authentication capability may be used within any suitable type of communication network configured to support one or more of CHAP, HTTP Digest Authentication, or the like. Accordingly, it will be appreciated that, although primarily depicted and described herein with respect to embodiments in which the user device is a specific type of user device (namely, a UE of a particular type of cellular wireless network) including a specific type of user device shell (e.g., an ME or MS) and a specific type of network authentication module (e.g., a UICC module), the user device may be any suitable type of user device (e.g., mobile user device, fixed user device, or the like, which may be used within a wireless network or wireline network) including any suitable type of user device shell and any suitable type of network authentication module including subscription information (e.g., a module such as a smartcard, a non-smartcard-based implementation, or the like). Similarly, it will be appreciated that, although primarily depicted and described herein with respect to embodiments in which the network device is a specific type of network device (namely, a subscriber server such as an HLR, an HSS, or the like), the network device may be any suitable type of network device which may perform authentication functions based on a request of a user device to access a communication network.

It will be appreciated that, although primarily depicted and described with respect to use of the authentication capability within specific types of environments, frameworks, or contexts (e.g., cellular-based communication networks), the authentication capability may be used within any security framework that is based on a challenge-response protocol.

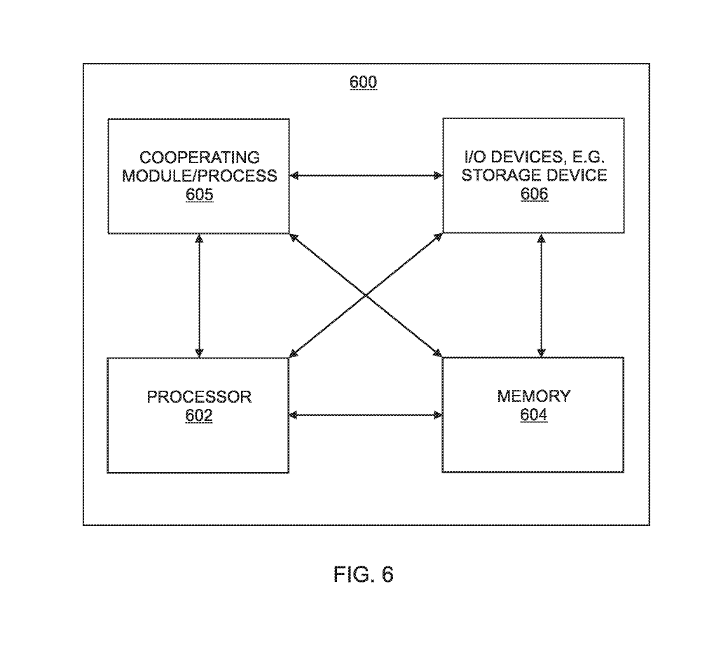

FIG. 6 depicts a high-level block diagram of a computer suitable for use in performing functions described herein.

As depicted in FIG. 6, the computer 600 includes a processor 602 (e.g., a central processing unit (CPU) and/or other suitable processor(s)) and a memory 604 (e.g., random access memory (RAM), read only memory (ROM), and the like).

As depicted in FIG. 6, the computer 600 also may include a cooperating module/process 605. The cooperating process 605 can be loaded into memory 604 and executed by the processor 602 to implement functions as discussed herein and, thus, cooperating process 605 (including associated data structures) can be stored on a computer readable storage medium, e.g., RAM memory, magnetic or optical drive or diskette, and the like.

As depicted in FIG. 6, the computer 600 also may include one or more input/output devices 606 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 600 depicted in FIG. 6 provides a general architecture and functionality suitable for implementing functional elements described herein and/or portions of functional elements described herein. For example, the computer 600 provides a general architecture and functionality suitable for implementing one or more of a network device (e.g., HLR/HSS or any other network device performing functions of network devices depicted and described herein), an element of an access network (e.g., an element of a RAN, an element of a wireline access network, or the like), a user device (e.g., a mobile user device such as a UE or any other mobile user device performing functions of mobile user devices depicted and described herein, a wireline user device, a multi-mode user device, or any other type of user device which may be involved in a challenge-response authentication procedure when accessing a communication network), or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or,” unless otherwise indicated (e.g., “or else” or “or in the alternative”).

It will be appreciated that, while the foregoing is directed to various embodiments of features present herein, other and further embodiments may be devised without departing from the basic scope thereof.

What is claimed is:

1. An apparatus configured to support an authentication procedure, the apparatus comprising:
a processor and a memory communicatively connected to the processor, the processor configured to:
process an authentication challenge parameter based on a cryptographic function to form a modified authentication challenge parameter; and
generate one or more authentication parameters based on the modified authentication challenge parameter.

2. The apparatus of claim 1, wherein the processor is configured to process the authentication challenge parameter based on the cryptographic function using a device-specific secret key.

3. The apparatus of claim 2, wherein the device-specific secret key is associated with a mobile equipment portion of a user device.

4. The apparatus of claim 3, wherein the processor is configured to retrieve the device-specific secret key from the memory based on a mapping of the device-specific secret key to a subscriber identity associated with a network authentication module of the user device.

5. The apparatus of claim 1, wherein the cryptographic function comprises a hash function or a cipher.

6. The apparatus of claim 1, wherein the processor is configured to:
propagate the authentication challenge parameter toward an access network.

7. The apparatus of claim 1, wherein the processor is configured to:
generate an authentication vector comprising the authentication challenge parameter; and
propagate the authentication vector toward an access network.

8. The apparatus of claim 1, wherein the one or more authentication parameters comprises a challenge response parameter.

9. The apparatus of claim 1, wherein the apparatus is a network device configured for association with an access network or a user device configured to access an access network.

10. A method, comprising:
using a processor and a memory for processing an authentication challenge parameter based on a cryptographic function to form a modified authentication challenge parameter; and
generating one or more authentication parameters based on the modified authentication challenge parameter.

11. An apparatus, comprising:
a first module comprising a processor and a memory, the first module configured to process an authentication challenge parameter based on a cryptographic function to form a modified authentication challenge parameter; and
a second module configured to generate one or more authentication parameters based on the modified authentication challenge parameter.

12. The apparatus of claim 11, wherein the first module is configured to receive the authentication challenge parameter from an access network.

13. The apparatus of claim 11, wherein the processor is configured to process the authentication challenge parameter based on the cryptographic function using a device-specific secret key.

14. The apparatus of claim 13, wherein the device-specific secret key is associated with a mobile equipment (ME) portion of the apparatus.

15. The apparatus of claim 11, wherein the first module is configured to propagate the modified authentication challenge parameter to the second module.

16. The apparatus of claim 11, wherein the first module is a mobile equipment (ME) portion of the apparatus and the second module is a network authentication module (NAM) of the apparatus.

17. The apparatus of claim 16, wherein the NAM comprises a Universal Integrated Circuit Card (UICC).

18. The apparatus of claim 11, wherein the second module is configured to provide at least one of the one or more authentication parameters to the first module.

19. The apparatus of claim 18, wherein the first module is configured to:
receive the at least one of the one or more authentication parameters from the second module; and
propagate the at least one of the one or more authentication parameters toward an access network.
